(19) United States
(12) Patent Application Publication
(10) Pub. No.: US 2026/0109636 A1
(43) Pub. Date: Apr. 23, 2026

(54) Intelligent, efficient and high-value manure treatment system based on ecological livestock and poultry farming and method therefor

(71) Applicants: Institute of Subtropical Agriculture, Chinese Academy of Sciences, Changsha City (CN); Hunan Normal University, Changsha City (CN)

(72) Inventors: Liuqin He, Changsha City (CN); Jian Wu, Changsha City (CN); Tiejun Li, Changsha City (CN); Wenjie Tang, Changsha City (CN); Yulong Yin, Changsha City (CN); Xihong Zhou, Changsha City (CN); Wenxuan Wu, Changsha City (CN)

(73) Assignees: Institute of Subtropical Agriculture, Chinese Academy of Sciences, Changsha City (CN); Hunan Normal University, Changsha City (CN)

(21) Appl. No.: 19/270,760

(22) Filed: Jul. 16, 2025

(30) Foreign Application Priority Data
Aug. 6, 2024 (CN) 2024110686707

(51) Int. Cl. C02F 11/121; C02F 103/20

(52) U.S. Cl. CPC C02F 11/121; C02F 2103/20; C02F 2303/26

(57) ABSTRACT

The present invention relates to the technical field of livestock and poultry manure treatment, and in particular, to an intelligent manure treatment system based on green ecological breeding of livestock and poultry and a method therefor. The system comprises a processing box, wherein a feed frame is inserted at a position near a top middle portion of the processing box; a partition is fixedly installed at a position near one side at a bottom portion of an inner cavity of the processing box, and an inclined plate is fixedly installed at a bottom portion of another side of the partition; a first rectangular opening is provided at a front side of the inner cavity of the processing box near another side, a pull-out slot stalled at a position near a middle portion of the inner cavity of the processing box, and a second rectangular opening is provided at a bottom portion of the filter tank near another side; an extrusion assembly is arranged an inner cavity of the filter tank, through the extrusion assembly, a power output shaft of a servo motor rotates to move a threaded sleeve threadedly connected a threaded rod to a right side, and impurities left on top portions of the filter tank are pushed and squeezed to the right side, so as to facilitate the separation of sewage from impurities and the recycling of impurities.

### CROSS-REFERENCE

This application claims priority to China Patent Application No. 2024110686707 filed August 6 2024, the contents of which are hereby incorporated by reference in their entirety.

### Technical Field

The present invention relates to the technical field of livestock and poultry manure treatment, and in particular to an intelligent manure treatment system based on green and ecological livestock and poultry breeding and a method therefor.

### Background Technology

With the rapid development of livestock and poultry farming, the annual output of livestock and poultry waste is about 3.8 billion tons, but the comprehensive utilization rate is less than 60%, causing serious agricultural non-point source pollution. According to relevant statistical data, livestock and poultry manure pollution has become one of the three major pollution sources alongside industrial wastewater and domestic sewage. Untreated livestock and poultry manure seriously pollutes groundwater, surface water, crops, etc., causing environmental pollution and endangering people's health. Resource utilization of livestock and poultry manure can not only change the situation of environmental pollution, but also effectively utilize resources. However, when resource processing and utilization of livestock and poultry manure, it is necessary to first treat the manure reasonably, so corresponding utilization and treatment devices are needed.

### SUMMARY OF THE INVENTION

The purpose of the present invention is to provide an intelligent manure treatment system based on green and ecological livestock and poultry breeding and a method therefor, so as to improve the effect of manure treatment.

To achieve the above-mentioned purposes, the present invention aims at providing an intelligent manure treatment system based on green ecological breeding of livestock and poultry, comprising a processing box, wherein a feed frame is inserted at a position near a top middle portion of the processing box; a partition is fixedly installed at a position near one side at a bottom portion of an inner cavity of the processing box, and an inclined plate is fixedly installed at a bottom portion of another side of the partition; a first rectangular opening is provided at a front side of the inner cavity of the processing box near another side, a pull-out slot movably penetrates the first rectangular opening; a filter tank is jointly fixedly installed at a position near a middle portion of the inner cavity of the processing box, and a second rectangular opening is provided at a bottom portion of the filter tank near another side; an extrusion assembly is arranged an inner cavity of the filter tank; a striking assembly is arranged near top portions of the inner cavity of the processing box; and an adjusting assembly is arranged at a position near a middle portion of a rear side of the processing box; and
the extrusion assembly comprises a servo motor located at a position near a middle portion of one side of the partition and a threaded rod fixedly mounted at a power output shaft end portion of the servo motor, another end portion of the threaded rod movably penetrates through an inner cavity of the partition and is rotationally connected to another side of the inner cavity of the filter tank, a threaded sleeve is threaded onto an outer circumference portion of the threaded rod near one end potion, and limit rods movably penetrate through both sides of the threaded sleeve, two end portions of the limit rods are respectively fixedly connected to the side walls of the inner cavity of the filter tank.

Preferably, a support plate is fixedly mounted on bottom portions of the servo motor, and another side of the support plate is fixedly connected to the partition.

Preferably, one side of the processing box is fixedly installed with a control panel, supporting legs are fixedly installed at bottom portions around four sides of the processing box, a third rectangular opening is provided at a front side of the processing box and near top portions, and transparent glass is fixedly installed in an inner cavity of the third rectangular opening, a sewage discharge pipe is inserted at a position near bottom portions on another side of the processing box, at another side of an inner cavity of the first rectangular opening is provided a trapezoidal groove, a trapezoidal block is slidably connected within the trapezoidal groove, and one side of the trapezoidal block is fixedly connected to the pull-out slot.

Preferably, the adjustment assembly comprises a sealing plate located at a bottom portion of an inner cavity of the second rectangular opening and a connecting shaft positioned on one side of the sealing plate; a rear side of the connecting shaft movably penetrates a rear side of the inner cavity of the processing box and is fixedly mounted with a tooth block B; a special-shaped rod is fixedly mounted on a top portion of the threaded sleeve near a rear side, a fourth rectangular opening is opened on a rear side of the inner cavity of the processing box near the top portions, and a rear end portion of the special-shaped rod movably passes through an inner cavity of the fourth rectangular opening, a rack plate is arranged at a bottom end portion of the special-shaped rod, an L-shaped plate is fixedly mounted on the rear side of the processing box near another side, and a transmission gear is arranged on a front side of the L-shaped plate near top portions, a bottom portion of the transmission gear are meshed with a rotating gear, and a tooth block A is arranged on a front side of the rotating gear, and the tooth block A and the tooth block B are arranged to engage mutually.

Preferably, fixing blocks are fixedly sleeved on positions of the connecting shaft which are near two end portions thereof, and another side of the fixing blocks is fixedly connected to a sealing plate, and sides that the fixing blocks are away from each other are provided with vertical blocks, and top portions of the vertical blocks are fixedly connected to the filter tank, and two end portions of the connecting shaft are respectively and movably penetrated through adjacent vertical blocks, and outer circumferences of the vertical blocks are fixedly sleeved with torsion springs near front end portions, and two end portions of the torsion springs are respectively and fixedly connected to the connecting shaft and the adjacent vertical blocks.

Preferably, a telescopic rod B is fixedly installed near one side of a top portion of the rack plate, and an end portion of the telescopic rod B is fixedly connected to a bottom end portion of the special-shaped rod, a spring B is movably sleeved on the telescopic rod B, and two end portions of the spring B are respectively fixedly connected to bottom end portions of the rack plate and the special-shaped rod, a limit block is fixedly installed on a top portion of the rack plate near one side, and the limit block (843) is slidably connected to the rear side of the processing box.

Preferably, a fixed shaft A is fixedly installed at a center of a rear side of a transmission gear, and a rear end portion of the fixed shaft A is rotationally connected to a front side of an inner cavity of the L-shaped plate; a fixed shaft B is fixedly installed at a center of a rear side of a rotating gear, and a rear end portion of the fixed shaft B is rotationally connected to the L-shaped plate; a telescopic rod A is fixedly installed at a center of a rear side of a tooth block A (87), and a rear end portion of the telescopic rod A is fixedly connected to the fixed shaft B, and a spring A is movably sleeved on the telescopic rod A, and two end portions of the spring A are respectively fixedly connected to front end portions of both the tooth block A and the fixed shaft B.

Preferably, the knocking assembly comprises a driving wheel located in an inner cavity of the feed frame and a worm movably penetrating the driving wheel; another end portion of the worm is rotationally connected to another side of the inner cavity of the feed frame; one end portion of the worm movably penetrates the feed frame and one side of the inner cavity of the partition; a worm wheel is meshed at a bottom portion of the worm; a transmission rod is provided at a center of a front side of the worm wheel; a rear end portion of the transmission rod is rotationally connected to a rear side of the inner cavity of the processing box; a movable rod is provided at a bottom portion of the transmission rod; a rear end portion of the movable rod is rotationally connected to the rear side of the inner cavity of the processing box; a bevel gear A is fixedly mounted on a front end portion of the movable rod, a bevel gear B is meshed with one side of the bevel gear A, and a cross bar is fixedly mounted at another center of the bevel gear B, and one end portion of the cross bar movably passes through one side of the inner cavity of the partition and is fixedly mounted with an eccentric wheel, and top portions of the eccentric wheel are arranged to fit bottom portions of the filter tank mutually.

Preferably, grooved wheels are fixedly sleeved on the movable rod and the transmission rod near front end portions, and a transmission belt is sleeved between the grooved wheels.

A processing method for the intelligent manure treatment system based on green ecological breeding of livestock and poultry comprises: manure is poured from top portions of the feed frame, then able to enter a top surface of the inclined plate through filtration of the filter tank, leaving impurities in top portions of the filter tank;
under impact of manure water, the drive wheel rotates, which in turn causes the worm fixed on the drive wheel to rotate, thus enabling the worm wheel that meshes with the worm to rotate, thereby further allowing the transmission rod to rotate, the grooved wheels and transmission belt, drive the movable rod to rotate, under transmission of the bevel gear A and the bevel gear B, the crossbar is made to rotate, which enables the eccentric wheel fixed on the crossbar to rotate, thereby striking the bottom portions of the filter tank to avoid clogging and affecting the efficiency of impurity separation from the manure;
when a certain amount of impurities accumulates at top portions of the filter tank, the servo motor is started via the control panel, the power output shaft of the servo motor rotates, causing the threaded rod fixed at the end portion of the power output shaft of the servo motor to rotate, which allows the threaded sleeve connected to the threaded rod to move to right under limiting of the limit rods, thus squeezing wastewater from the impurities, facilitating separation of wastewater from impurities for recycling;
under connection of the special-shaped rod, the rack plate can move to the right, when the rack plate meshes with the transmission gear, the rotating gear is made to rotate, allowing the tooth block A to rotate clockwise under cooperation of the telescopic rod A and the spring A, and, the tooth block B cannot rotate; when the rack plate moves to a left, the tooth block B can rotate counterclockwise, thus allowing the connecting shaft to rotate counterclockwise, and then the sealing plate is opened, and extruded impurities fall into an inner cavity of the pull-out slot; when the rack plate is separated from the transmission gear, the sealing plate is restored to an initial state under action of the torsion springs, so that the extruded impurities are conveniently collected, and there is no need for workers to directly remove the impurities after squeezing once, thereby reducing workloads of workers; and
after sewage is separated, it is connected to the sewage discharge pipe through an external setting to discharge the sewage in the processing box.

Compared with the prior art, beneficial effects of the present invention are as follows:
I. In the intelligent manure treatment system based on green ecological breeding of livestock and poultry and the method therefor, the extrusion assembly can make the threaded sleeve connected to the threaded rod move to the right under the rotation of the power output shaft of the servo motor, and push and squeeze the impurities left on the top of the filter tank to the right, so as to separate the sewage from the impurities and recycle the impurities.
II. In the intelligent manure treatment system based on green ecological breeding of livestock and poultry and the method therefor, through the adjustment assembly, when the threaded sleeve moves to the right, the rack plate can be moved to the right through the connection of the special-shaped rod, and when the rack plate is engaged with the transmission gear, the rotating gear can be rotated, so that the gear block A can rotate clockwise in cooperation with the telescopic rod A and the spring A, and the gear block B cannot be rotated. When the rack plate moves to the left, the gear block B can be rotated counterclockwise, so that the connecting shaft can be rotated counterclockwise, and then the sealing plate can be opened, and the extruded impurities fall into the inner cavity of the pull-out slot. When the rack plate is separated from the transmission gear, the sealing plate can be restored to the initial state under the action of the torsion spring, which is convenient for collecting the extruded impurities, and the staff does not need to directly take out the impurities after squeezing once, thereby reducing the staff's work intensity.
III. In the intelligent manure treatment system based on green ecological breeding of livestock and poultry and the method therefor, the driving wheel can be rotated by the knocking assembly under the impact of sewage, and the cross bar can be rotated by the cooperation of the driving wheel, worm, worm wheel, transmission rod, movable rod, bevel gear A and bevel gear B, so that the eccentric wheel fixed on the cross bar can be rotated, and the bottom of the filter tank can be knocked, so as to avoid clogging of the filter tank and improve the efficiency of separation of manure and impurities.

### BRIEF DESCRIPTION OF THE DRAWINGS

FIG. 1 is a schematic diagram of an overall three-dimensional structure of the present invention.

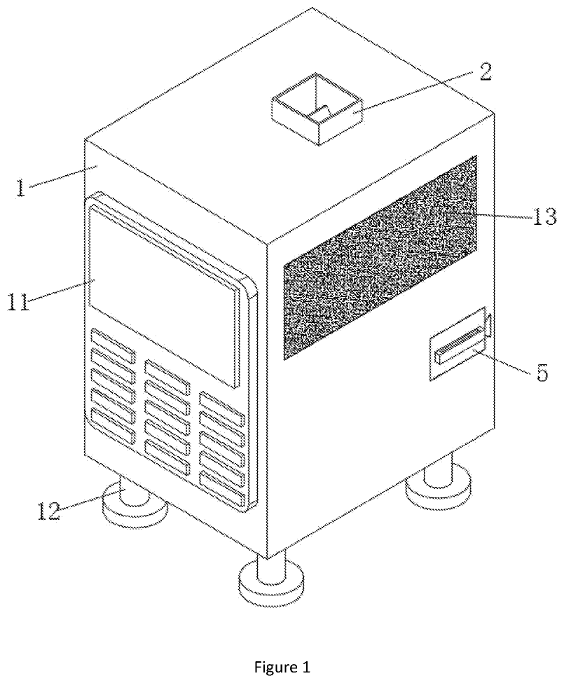

FIG. 2 is a schematic diagram of the overall three-dimensional structure of the present invention from another perspective.

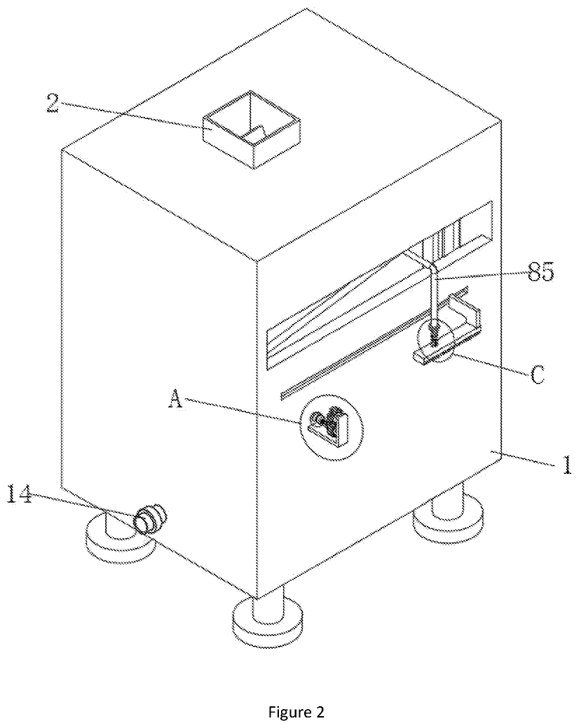

FIG. 3 is a schematic diagram of a partial cross-sectional three-dimensional structure of the present invention.

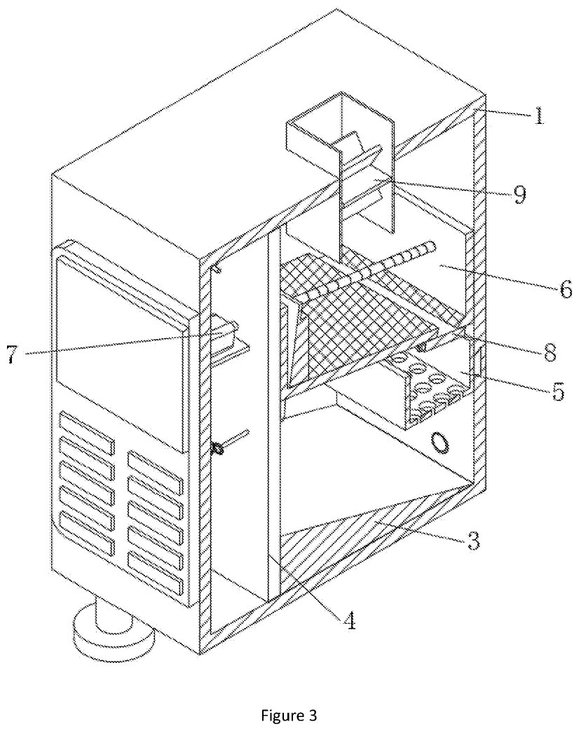

FIG. 4 is a schematic diagram of a three-dimensional structure of a knocking assembly of the present invention.

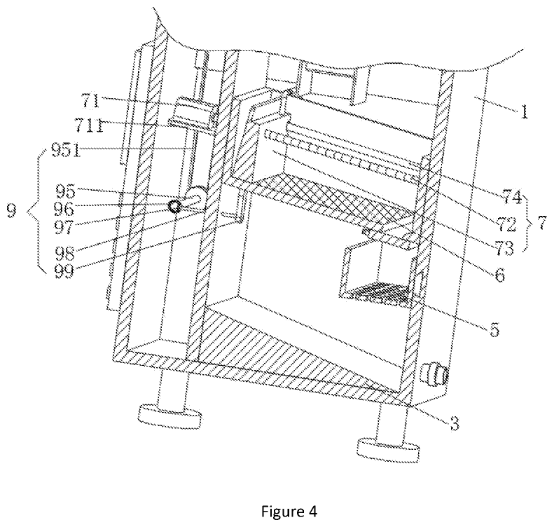

FIG. 5 is a schematic diagram of the three-dimensional structure of the transmission belt and filter tank of the present invention.

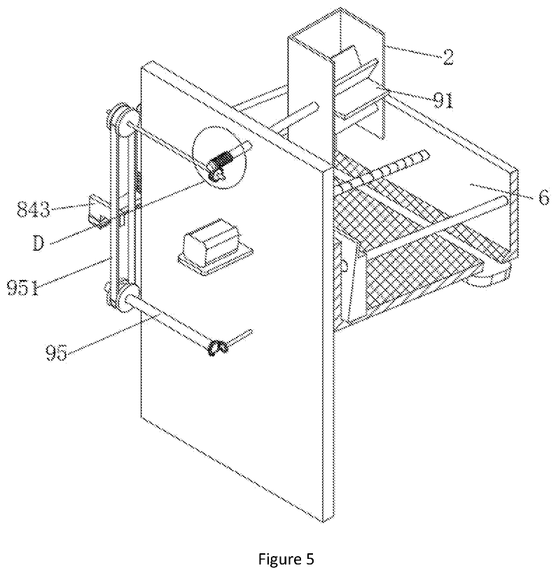

FIG. 6 is a schematic diagram of a three-dimensional structure of a partition and a filter tank of the present invention.

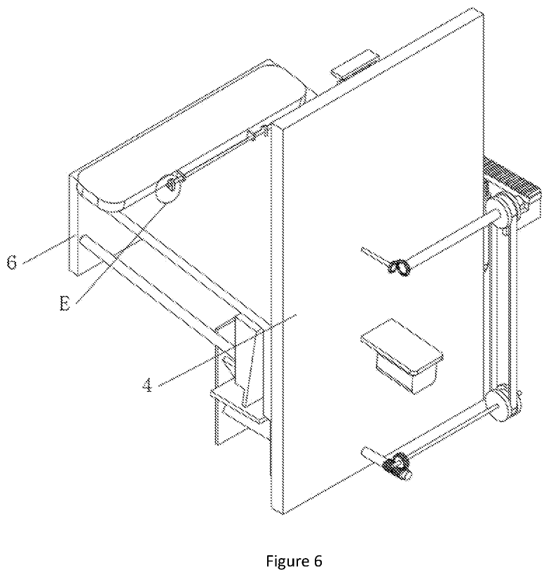

FIG. 7 is an enlarged view of part “A” in FIG. 2 of the present invention.

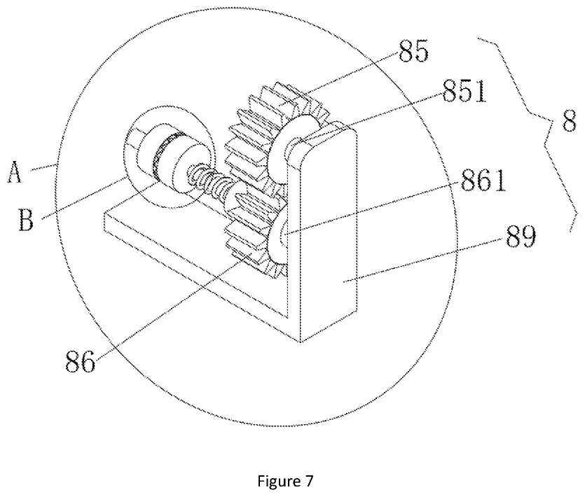

FIG. 8 is an enlarged view of part “B” in FIG. 7 of the present invention.

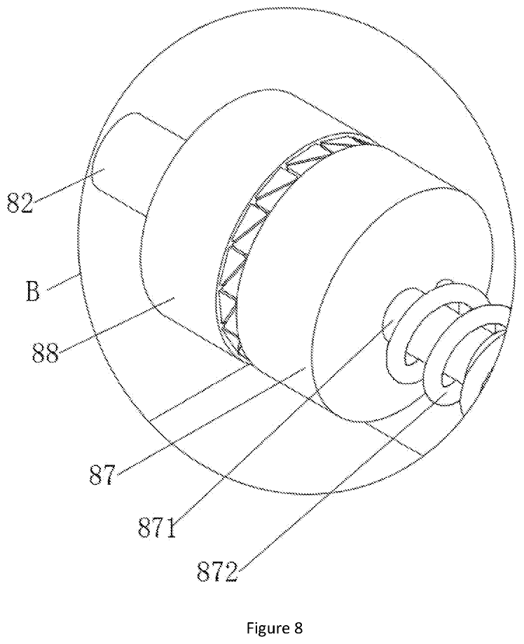

FIG. 9 is an enlarged view of part “C” in FIG. 2 of the present invention.

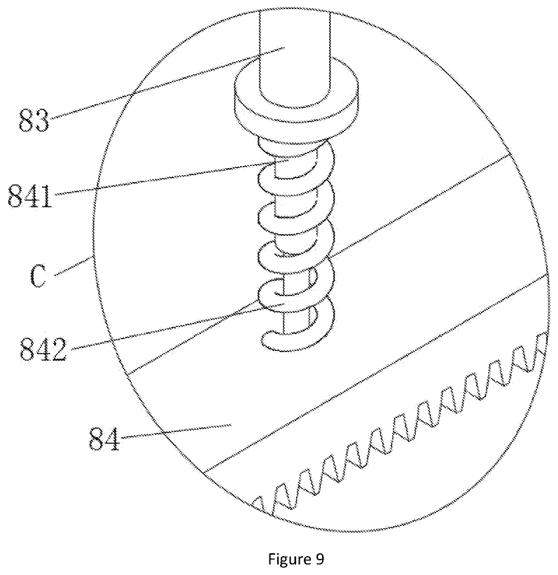

FIG. 10 is an enlarged view of part “D” in FIG. 5 of the present invention.

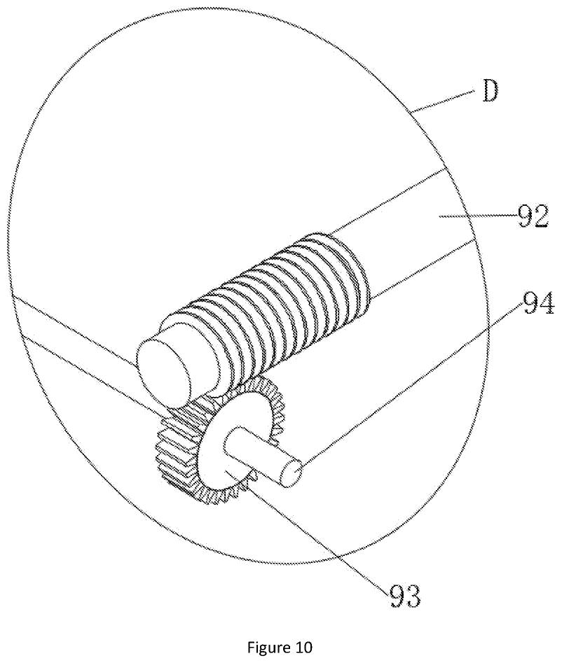

FIG. 11 is an enlarged view of part “E” in FIG. 6 of the present invention.

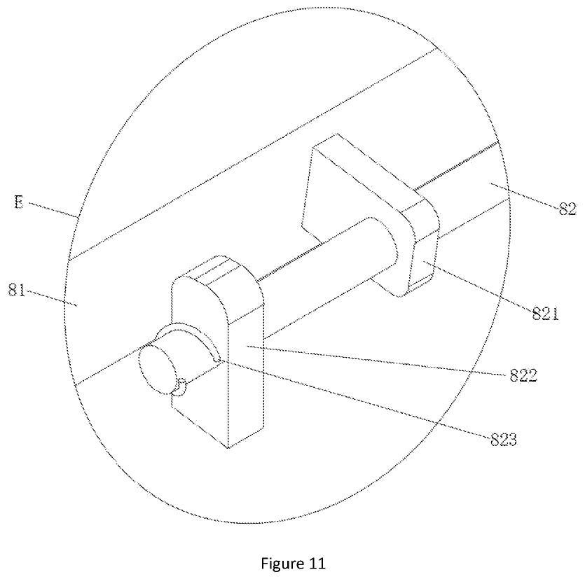

The markups in the drawings are indicated as follows:
1—processing box;
11—control panel;
12—supporting leg;
13—transparent glass;
14—sewage discharge pipe;
2—feed frame;
3—inclined plate;
4—partition;
5—pull-out slot;
51—trapezoidal block;
6—filter tank;
7—extrusion assembly;
71—servo motor;
711—support plate;
72—threaded rod;
73—threaded sleeve;
74—limiting rod;
8—adjustment assembly;
81—sealing plate;
82—connecting shaft;
821—fixing block;
822—vertical block;
823—torsion spring;
83—special-shaped rod;
84—rack plate;
841—telescopic rod B;
842—spring B;
843—limit block;
85—transmission gear;
851—fixed shaft A;
86—rotating gear;
861—fixed shaft B;
87—tooth block A;
871—telescopic rod A;
872—spring A;
88—tooth block B;
89—L-shaped plate;
9—knocking assembly;
91—driving wheel;
92—worm;
93—worm wheel;
94—transmission rod;
95—movable rod;
951—transmission belt;
96—bevel gear A;
97—bevel gear B;
98—cross bar; and
99—eccentric wheel;

### SPECIFIC EMBODIMENTS

The following will be combined with accompanying drawings in embodiments of the present invention to clearly and completely describe the technical solutions in the embodiments of the present invention. Obviously, the described embodiments are some embodiments of the present invention, rather than all the embodiments. Based on the embodiments of the present invention, all other embodiments obtained by ordinary technicians in this field without creative work are within the scope of protection of the present invention.

In the description of the present invention, it should be understood that the terms “center”, “longitudinal”, “lateral”, “length”, “width”, “thickness”, “up”, “down”, “front”, “rear”, “left”, “right”, “vertical”, “horizontal”, “top”, “bottom”, “inside”, “outside”, “clockwise”, “counterclockwise” and the like indicate orientations or positional relationships based on the orientations or positional relationships shown in the accompanying drawings, and are only for the convenience of describing the present invention and simplifying the description, and do not indicate or imply that the referred device or element must have a specific orientation, be constructed and operated in a specific orientation, and therefore should not be understood as limiting the present invention.

An embodiment of the present invention aims to provide an intelligent manure treatment system based on green ecological breeding of livestock and poultry, comprising a processing box 1, wherein a feed frame 2 is inserted at a position near a top middle portion of the processing box 1; a partition 4 is fixedly installed at a position near one side at a bottom portion of an inner cavity of the processing box 1, and an inclined plate 3 is fixedly installed at a bottom portion of another side of the partition 4; a first rectangular opening is provided at a front side of the inner cavity of the processing box 1 near another side, a pull-out slot 5 movably penetrates the first rectangular opening; a filter tank 6 is jointly fixedly installed at a position near a middle portion of the inner cavity of the processing box 1, and a second rectangular opening is provided at a bottom portion of the filter tank 6 near another side; an extrusion assembly 7 is arranged an inner cavity of the filter tank 6; a striking assembly 9 is arranged near top portions of the inner cavity of the processing box 1; and an adjusting assembly 8 is arranged at a position near a middle portion of a rear side of the processing box 1; and
the extrusion assembly 7 comprises a servo motor 71 located at a position near a middle portion of one side of the partition 4 and a threaded rod 72 fixedly mounted at a power output shaft end portion of the servo motor 71, another end portion of the threaded rod 72 movably penetrates through an inner cavity of the partition 4 and is rotationally connected to another side of the inner cavity of the filter tank 6, a threaded sleeve 73 is threaded onto an outer circumference portion of the threaded rod 72 near one end potion, and limit rods 74 movably penetrate through both sides of the threaded sleeve 73, two end portions of the limit rods 74 are respectively fixedly connected to the side walls of the inner cavity of the filter tank 6.

A support plate 711 is fixedly mounted on bottom portions of the servo motor 71, and another side of the support plate 711 is fixedly connected to the partition 4.

One side of the processing box 1 is fixedly installed with a control panel 11, supporting legs 12 are fixedly installed at bottom portions around four sides of the processing box 1, a third rectangular opening is provided at a front side of the processing box 1 and near top portions, and transparent glass 13 is fixedly installed in an inner cavity of the third rectangular opening, a sewage discharge pipe 14 is inserted at a position near bottom portions on another side of the processing box (1), at another side of an inner cavity of the first rectangular opening is provided a trapezoidal groove, a trapezoidal block 51 is slidably connected within the trapezoidal groove, and one side of the trapezoidal block 51 is fixedly connected to the pull-out slot 5.

The adjustment assembly 8 comprises a sealing plate 81 located at a bottom portion of an inner cavity of the second rectangular opening and a connecting shaft 82 positioned on one side of the sealing plate 81; a rear side of the connecting shaft 82 movably penetrates a rear side of the inner cavity of the processing box 1 and is fixedly mounted with a tooth block B 88; a special-shaped rod 83 is fixedly mounted on a top portion of the threaded sleeve 73 near a rear side, a fourth rectangular opening is opened on a rear side of the inner cavity of the processing box 1 near the top portions, and a rear end portion of the special-shaped rod 83 movably passes through an inner cavity of the fourth rectangular opening, a rack plate 84 is arranged at a bottom end portion of the special-shaped rod 83, an L-shaped plate 89 is fixedly mounted on the rear side of the processing box 1 near another side, and a transmission gear 85 is arranged on a front side of the L-shaped plate 89 near top portions, a bottom portion of the transmission gear 85 are meshed with a rotating gear 86, and a tooth block A 87 is arranged on a front side of the rotating gear 86, and the tooth block A 87 and the tooth block B 88 are arranged to engage mutually. When the threaded sleeve 73 moves to the right, the rack plate 84 moves to the right through the connection of the special-shaped rod 83; when the rack plate 84 is meshed with the transmission gear 85, the rotating gear 86 can be rotated, so that the tooth block A 87 can rotate clockwise under the cooperation of the telescopic rod A 871 and the spring A 872, and the tooth block B 88 cannot be rotated; when the rack plate 84 moves to the left, the tooth block B 88 can be rotated counterclockwise, so that the connecting shaft 82 can rotate counterclockwise, and then the sealing plate 81 can be opened, and the extruded impurities fall into the inner cavity of the pull-out slot 5; and when the rack plate 84 is separated from the transmission gear 85, the sealing plate 81 can be restored to its initial state under the action of the torsion spring 823, which is convenient for collecting the extruded impurities. There is no need for the staff to directly take out the impurities after squeezing once, thereby reducing the work intensity of the staff.

Fixing blocks 821 are fixedly sleeved on positions of the connecting shaft 82 which are near two end portions thereof, and another side of the fixing blocks 821 is fixedly connected to a sealing plate 81, and sides that the fixing blocks 821 are away from each other are provided with vertical blocks 822, and top portions of the vertical blocks 822 are fixedly connected to the filter tank 6, and two end portions of the connecting shaft 82 are respectively and movably penetrated through adjacent vertical blocks 822, and outer circumferences of the vertical blocks 822 are fixedly sleeved with torsion springs 823 near front end portions, and two end portions of the torsion springs 823 are respectively and fixedly connected to the connecting shaft 82 and the adjacent vertical blocks 822. The sealing plate 81 can be restored to its initial state by setting the torsion springs 823

A telescopic rod B 841 is fixedly installed near one side of a top portion of the rack plate 84, and an end portion of the telescopic rod B 841 is fixedly connected to a bottom end portion of the special-shaped rod 83, a spring B 842 is movably sleeved on the telescopic rod B 841, and two end portions of the spring B 842 are respectively fixedly connected to bottom end portions of the rack plate 84 and the special-shaped rod 83, a limit block 843 is fixedly installed on a top portion of the rack plate 84 near one side, and the limit block 843 is slidably connected to the rear side of the processing box 1.

A fixed shaft A 851 is fixedly installed at a center of a rear side of a transmission gear 85, and a rear end portion of the fixed shaft A 851 is rotationally connected to a front side of an inner cavity of the L-shaped plate 89; a fixed shaft B 861 is fixedly installed at a center of a rear side of a rotating gear 86, and a rear end portion of the fixed shaft B 861 is rotationally connected to the L-shaped plate 89; a telescopic rod A 871 is fixedly installed at a center of a rear side of a tooth block A 87, and a rear end portion of the telescopic rod A 871 is fixedly connected to the fixed shaft B (861), and a spring A 872 is movably sleeved on the telescopic rod A 871, and two end portions of the spring A 872 are respectively fixedly connected to front end portions of both the tooth block A 87 and the fixed shaft B 861.

The knocking assembly 9 comprises a driving wheel 91 located in an inner cavity of the feed frame 2 and a worm 92 movably penetrating the driving wheel 91; another end portion of the worm 92 is rotationally connected to another side of the inner cavity of the feed frame 2; one end portion of the worm 92 movably penetrates the feed frame 2 and one side of the inner cavity of the partition 4; a worm wheel 93 is meshed at a bottom portion of the worm 92; a transmission rod 94 is provided at a center of a front side of the worm wheel 93; a rear end portion of the transmission rod 94 is rotationally connected to a rear side of the inner cavity of the processing box 1; a movable rod 95 is provided at a bottom portion of the transmission rod 94; a rear end portion of the movable rod 95 is rotationally connected to the rear side of the inner cavity of the processing box 1; a bevel gear A 96 is fixedly mounted on a front end portion of the movable rod 95, a bevel gear B 97 is meshed with one side of the bevel gear A 96, and a cross bar 98 is fixedly mounted at another center of the bevel gear B 97, and one end portion of the cross bar 98 movably passes through one side of the inner cavity of the partition 4 and is fixedly mounted with an eccentric wheel 99, and top portions of the eccentric wheel 99 are arranged to fit bottom portions of the filter tank 6 mutually. The driving wheel 91 can be rotated under the impact of sewage, and the cross bar 98 can be rotated through the cooperation of the driving wheel 91, the worm 92, the worm wheel 93, the transmission rod 94, the movable rod 95, the bevel gear A 96 and the bevel gear B 97, so that the eccentric wheel 99 fixed on the cross bar 98 can be rotated, and the bottom of the filter tank 6 can be knocked, thereby avoiding the blockage of the filter tank 6 and improving the efficiency of separating manure and impurities.

Grooved wheels are fixedly sleeved on the movable rod 95 and the transmission rod 94 near front end portions, and a transmission belt 951 is sleeved between the grooved wheels.

A processing method for the intelligent manure treatment system based on green ecological breeding of livestock and poultry comprises:
manure is poured from top portions of the feed frame 2, then able to enter a top surface of the inclined plate 3 through filtration of the filter tank 6, leaving impurities in top portions of the filter tank 6;
under impact of manure water, the drive wheel 91 rotates, which in turn causes the worm 92 fixed on the drive wheel 91 to rotate, thus enabling the worm wheel 93 that meshes with the worm 92 to rotate, thereby further allowing the transmission rod 94 to rotate, the grooved wheels and transmission belt 951, drive the movable rod 95 to rotate, under transmission of the bevel gear A 96 and the bevel gear B 97, the crossbar 98 is made to rotate, which enables the eccentric wheel 99 fixed on the crossbar 98 to rotate, thereby striking the bottom portions of the filter tank 6 to avoid clogging and affecting the efficiency of impurity separation from the manure; when a certain amount of impurities accumulates at top portions of the filter tank 6, the servo motor 71 is started via the control panel 11, the power output shaft of the servo motor 71 rotates, causing the threaded rod 72 fixed at the end portion of the power output shaft of the servo motor 71 to rotate, which allows the threaded sleeve 73 connected to the threaded rod 72 to move to right under limiting of the limit rods 74, thus squeezing wastewater from the impurities, facilitating separation of wastewater from impurities for recycling;
under connection of the special-shaped rod 83, the rack plate 84 can move to the right, when the rack plate 84 meshes with the transmission gear 85, the rotating gear 86 is made to rotate, allowing the tooth block A 87 to rotate clockwise under cooperation of the telescopic rod A 871 and the spring A 872, and, the tooth block B 88 cannot rotate; when the rack plate 84 moves to a left, the tooth block B 88 can rotate counterclockwise, thus allowing the connecting shaft 82 to rotate counterclockwise, and then the sealing plate 81 is opened, and extruded impurities fall into an inner cavity of the pull-out slot 5; when the rack plate 84 is separated from the transmission gear 85, the sealing plate 81 is restored to an initial state under action of the torsion springs 823, so that the extruded impurities are conveniently collected, and there is no need for workers to directly remove the impurities after squeezing once, thereby reducing workloads of workers; and
after sewage is separated, it is connected to the sewage discharge pipe 14 through an external setting to discharge the sewage in the processing box 1.

In summary, the working principle of the present invention is as follows: manure is poured from top portions of the feed frame 2, then able to enter a top surface of the inclined plate 3 through filtration of the filter tank 6, leaving impurities in top portions of the filter tank 6;
under impact of manure water, the drive wheel 91 rotates, which in turn causes the worm 92 fixed on the drive wheel 91 to rotate, thus enabling the worm wheel 93 that meshes with the worm 92 to rotate, thereby further allowing the transmission rod 94 to rotate, the grooved wheels and transmission belt 951, drive the movable rod 95 to rotate, under transmission of the bevel gear A 96 and the bevel gear B 97, the crossbar 98 is made to rotate, which enables the eccentric wheel 99 fixed on the crossbar 98 to rotate, thereby striking the bottom portions of the filter tank 6 to avoid clogging and affecting the efficiency of impurity separation from the manure; when a certain amount of impurities accumulates at top portions of the filter tank 6, the servo motor 71 is started via the control panel 11, the power output shaft of the servo motor 71 rotates, causing the threaded rod 72 fixed at the end portion of the power output shaft of the servo motor 71 to rotate, which allows the threaded sleeve 73 connected to the threaded rod 72 to move to right under limiting of the limit rods 74, thus squeezing wastewater from the impurities, facilitating separation of wastewater from impurities for recycling; and
under connection of the special-shaped rod 83, the rack plate 84 can move to the right, when the rack plate 84 meshes with the transmission gear 85, the rotating gear 86 is made to rotate, allowing the tooth block A 87 to rotate clockwise under cooperation of the telescopic rod A 871 and the spring A 872, and, the tooth block B 88 cannot rotate; when the rack plate 84 moves to a left, the tooth block B 88 can rotate counterclockwise, thus allowing the connecting shaft 82 to rotate counterclockwise, and then the sealing plate 81 is opened, and extruded impurities fall into an inner cavity of the pull-out slot 5; when the rack plate 84 is separated from the transmission gear 85, the sealing plate 81 is restored to an initial state under action of the torsion springs 823, so that the extruded impurities are conveniently collected, and there is no need for workers to directly remove the impurities after squeezing once, thereby reducing workloads of workers; and after sewage is separated, it is connected to the sewage discharge pipe 14 through an external setting to discharge the sewage in the processing box 1.

The basic principle, main features and advantages of the present invention are shown and described above. It should be understood by those skilled in the art that the present invention is not limited by the above embodiments. The above embodiments and descriptions are only preferred examples of the present invention and are not intended to limit the present invention. The present invention may be subject to various changes and improvements without departing from the spirit and scope of the present invention, and these changes and improvements fall within the scope of the present invention to be protected. The scope of protection of the present invention is defined by the attached claims and their equivalents.

1. An intelligent manure treatment system based on green ecological breeding of livestock and poultry, comprising a processing box (1), wherein a feed frame (2) is inserted at a position near a top middle portion of the processing box (1); a partition (4) is fixedly installed at a position near one side at a bottom portion of an inner cavity of the processing box (1), and an inclined plate (3) is fixedly installed at a bottom portion of another side of the partition (4), a first rectangular opening is provided at a front side of the inner cavity of the processing box (1) near another side, a pull-out slot (5) movably penetrates the first rectangular opening, a filter tank (6) is jointly fixedly installed at a position near a middle portion of the inner cavity of the processing box (1), a second rectangular opening is provided at a bottom portion of the filter tank (6) near another side, an extrusion assembly (7) is arranged an inner cavity of the filter tank (6), a striking assembly (9) is arranged near top portions of the inner cavity of the processing box (1), and an adjusting assembly (8) is arranged at a position near a middle portion of a rear side of the processing box (1); and
the extrusion assembly (7) comprises a servo motor (71) located at a position near a middle portion of one side of the partition (4) and a threaded rod (72) fixedly mounted at a power output shaft end portion of the servo motor (71), another end portion of the threaded rod (72) movably penetrates through an inner cavity of the partition (4) and is rotationally connected to another side of the inner cavity of the filter tank (6), a threaded sleeve (73) is threaded onto an outer circumference portion of the threaded rod (72) near one end potion, and limit rods (74) movably penetrate through both sides of the threaded sleeve (73), and two end portions of the limit rods (74) are respectively fixedly connected to the side walls of the inner cavity of the filter tank (6).

2. The intelligent manure treatment system based on green ecological breeding of livestock and poultry according to claim 1, wherein a support plate (711) is fixedly mounted on bottom portions of the servo motor (71), and another side of the support plate (711) is fixedly connected to the partition (4).

3. The intelligent manure treatment system based on green ecological breeding of livestock and poultry according to claim 1, wherein one side of the processing box (1) is fixedly installed with a control panel (11), supporting legs (12) are fixedly installed at bottom portions around four sides of the processing box (1), a third rectangular opening is provided at a front side of the processing box (1) and near top portions, and transparent glass (13) is fixedly installed in an inner cavity of the third rectangular opening, a sewage discharge pipe (14) is inserted at a position near bottom portions on another side of the processing box (1), at another side of an inner cavity of the first rectangular opening is provided a trapezoidal groove, a trapezoidal block (51) is slidably connected within the trapezoidal groove, and one side of the trapezoidal block (51) is fixedly connected to the pull-out slot (5).

4. The intelligent manure treatment system based on green ecological breeding of livestock and poultry according to claim 1, wherein the adjustment assembly (8) comprises a sealing plate (81) located at a bottom portion of an inner cavity of the second rectangular opening and a connecting shaft (82) positioned on one side of the sealing plate (81), a rear side of the connecting shaft (82) movably penetrates a rear side of the inner cavity of the processing box (1) and is fixedly mounted with a tooth block B (88), a special-shaped rod (83) is fixedly mounted on a top portion of the threaded sleeve (73) near a rear side, a fourth rectangular opening is opened on a rear side of the inner cavity of the processing box (1) near the top portions, and a rear end portion of the special-shaped rod (83) movably passes through an inner cavity of the fourth rectangular opening, a rack plate (84) is arranged at a bottom end portion of the special-shaped rod (83), an L-shaped plate (89) is fixedly mounted on the rear side of the processing box (1) near another side, and a transmission gear (85) is arranged on a front side of the L-shaped plate (89) near top portions, a bottom portion of the transmission gear (85) are meshed with a rotating gear (86), a tooth block A (87) is arranged on a front side of the rotating gear (86), and the tooth block A (87) and the tooth block B (88) are arranged to engage mutually.

5. The intelligent manure treatment system based on green ecological breeding of livestock and poultry according to claim 4, wherein fixing blocks (821) are fixedly sleeved on positions of the connecting shaft (82) which are near two end portions thereof, and another side of the fixing blocks (821) is fixedly connected to a sealing plate (81), sides that the fixing blocks (821) are away from each other are provided with vertical blocks (822), top portions of the vertical blocks (822) are fixedly connected to the filter tank (6), two end portions of the connecting shaft (82) are respectively and movably penetrated through adjacent vertical blocks (822), outer circumferences of the vertical blocks (822) are fixedly sleeved with torsion springs

(823) near front end portions, and two end portions of the torsion springs (823) are respectively and fixedly connected to the connecting shaft (82) and the adjacent vertical blocks (822).

6. The intelligent manure treatment system based on green ecological breeding of livestock and poultry according to claim 4, wherein a telescopic rod B (841) is fixedly installed near one side of a top portion of the rack plate (84), an end portion of the telescopic rod B (841) is fixedly connected to a bottom end portion of the special-shaped rod (83), a spring B (842) is movably sleeved on the telescopic rod B (841), two end portions of the spring B (842) are respectively fixedly connected to bottom end portions of the rack plate (84) and the special-shaped rod (83), a limit block (843) is fixedly installed on a top portion of the rack plate (84) near one side, and the limit block (843) is slidably connected to the rear side of the processing box (1).

7. The intelligent manure treatment system based on green ecological breeding of livestock and poultry according to claim 4, wherein a fixed shaft A (851) is fixedly installed at a center of a rear side of a transmission gear (85), and a rear end portion of the fixed shaft A (851) is rotationally connected to a front side of an inner cavity of the L-shaped plate (89); a fixed shaft B (861) is fixedly installed at a center of a rear side of a rotating gear (86), and a rear end portion of the fixed shaft B (861) is rotationally connected to the L-shaped plate (89); a telescopic rod A (871) is fixedly installed at a center of a rear side of a tooth block A (87), a rear end portion of the telescopic rod A (871) is fixedly connected to the fixed shaft B (861), a spring A (872) is movably sleeved on the telescopic rod A (871), and two end portions of the spring A (872) are respectively fixedly connected to front end portions of both the tooth block A (87) and the fixed shaft B (861).

8. The intelligent manure treatment system based on green ecological breeding of livestock and poultry according to claim 1, wherein the knocking assembly (9) comprises a driving wheel (91) located in an inner cavity of the feed frame (2) and a worm (92) movably penetrating the driving wheel (91), another end portion of the worm (92) is rotationally connected to another side of the inner cavity of the feed frame (2), one end portion of the worm (92) movably penetrates the feed frame (2) and one side of the inner cavity of the partition (4), a worm wheel (93) is meshed at a bottom portion of the worm (92), a transmission rod (94) is provided at a center of a front side of the worm wheel (93), a rear end portion of the transmission rod (94) is rotationally connected to a rear side of the inner cavity of the processing box (1), a movable rod (95) is provided at a bottom portion of the transmission rod (94), a rear end portion of the movable rod (95) is rotationally connected to the rear side of the inner cavity of the processing box (1), a bevel gear A (96) is fixedly mounted on a front end portion of the movable rod (95), a bevel gear B (97) is meshed with one side of the bevel gear A (96), a cross bar (98) is fixedly mounted at another center of the bevel gear B (97), one end portion of the cross bar (98) movably passes through one side of the inner cavity of the partition (4) and is fixedly mounted with an eccentric wheel (99), and top portions of the eccentric wheel (99) are arranged to fit bottom portions of the filter tank (6) mutually.

9. The intelligent manure treatment system based on green ecological breeding of livestock and poultry according to claim 8, wherein grooved wheels are fixedly sleeved on the movable rod (95) and the transmission rod (94) near front end portions, and a transmission belt (951) is sleeved between the grooved wheels.

10. A processing method for the intelligent manure treatment system based on green ecological breeding of livestock and poultry according to claim 1, comprising:
manure is poured from top portions of the feed frame (2), then able to enter a top surface of the inclined plate (3) through filtration of the filter tank (6), leaving impurities in top portions of the filter tank (6);
under impact of manure water, the drive wheel (91) rotates, which in turn causes the worm (92) fixed on the drive wheel (91) to rotate, thus enabling the worm wheel (93) that meshes with the worm (92) to rotate, thereby further allowing the transmission rod (94) to rotate, the grooved wheels and transmission belt (951), drive the movable rod (95) to rotate, under transmission of the bevel gear A (96) and the bevel gear B (97), the crossbar (98) is made to rotate, which enables the eccentric wheel (99) fixed on the crossbar (98) to rotate, thereby striking the bottom portions of the filter tank (6) to avoid clogging and affecting the efficiency of impurity separation from the manure;
when a certain amount of impurities accumulates at top portions of the filter tank (6), the servo motor (71) is started via the control panel (11), the power output shaft of the servo motor (71) rotates, causing the threaded rod (72) fixed at the end portion of the power output shaft of the servo motor (71) to rotate, which allows the threaded sleeve (73) connected to the threaded rod (72) to move to right under limiting of the limit rods (74), thus squeezing wastewater from the impurities, facilitating separation of wastewater from impurities for recycling;
under connection of the special-shaped rod (83), the rack plate (84) can move to the right, when the rack plate (84) meshes with the transmission gear (85), the rotating gear (86) is made to rotate, allowing the tooth block A (87) to rotate clockwise under cooperation of the telescopic rod A (871) and the spring A (872), and, the tooth block B (88) cannot rotate; when the rack plate (84) moves to a left, the tooth block B (88) can rotate counterclockwise, thus allowing the connecting shaft (82) to rotate counterclockwise, and then the sealing plate (81) is opened, and extruded impurities fall into an inner cavity of the pull-out slot (5); when the rack plate (84) is separated from the transmission gear (85), the sealing plate (81) is restored to an initial state under action of the torsion springs (823), so that the extruded impurities are conveniently collected, and there is no need for workers to directly remove the impurities after squeezing once, thereby reducing workloads of workers; and
after sewage is separated, it is connected to the sewage discharge pipe (14) through an external setting to discharge the sewage in the processing box (1).
